(19) United States
(12) Patent Application Publication
(10) Pub. No.: US 2004/0208804 A1
(43) Pub. Date: Oct. 21, 2004

(54) Non-thermal plasma reactor

(76) Inventors: Stephen Ivor Hall, Oxfordshire (GB); James Timothy Shawcross, Oxfordshire (GB); Roy McAdams, Oxfordshire (GB); David Leslie Segal, Oxfordshire (GB); Michael Inman, Oxfordshire (GB); Keith Morris, Oxfordshire (GB); David Raybone, Gloucestershire (GB); John Stedman, Oxfordshire (GB)

Correspondence Address: Law Offices of William H Holt, First Floor Unit 2, 1423 Powhatan Street, Alexandria, VA, 22314, US

(21) Appl. No.: 10/486,724

(22) PCT Filed: Aug. 20, 2002
(86) PCT No.: PCT/GB02/03843

(30) Foreign Application Priority Data
Aug. 25, 2001 (GB) 01 20775.2
Nov. 29, 2001 (GB) 01 285295

(51) Int. Cl. B01J 19/08

(52) U.S. Cl. 422/186.04

(57) ABSTRACT

The space between parallel electrode plates (12, 13) of the reactor is dimensioned to make it possible to produce plasma at reasonable applied potential within the gas passages (15) of a monolithic substrate, such as a wallflow filter, in a slice (11) positioned between the electrode plates (12, 13).

The invention relates to a non-thermal plasma reactor and in one aspect to such a reactor for the treatment of exhaust gases from an internal combustion engine to remove or reduce pollutants such as carbonaceous particulates and oxides of nitrogen. In another aspect the invention relates to a non-thermal plasma reactor for the treatment of air which is to be re-circulated to the cabins in an aircraft.

Diesel particulate filters, known as wallflow filters, are used widely nowadays as particulate traps for diesel exhausts. Carbonaceous particulates, such as those found in diesel exhaust, are primarily of carbon (soot), but include hydrocarbons such as but not exclusively soluble organic fractions which may, for example, be adsorbed on the surface of soot particles. A typical cylindrical wallflow filter dimension is 5.66 inches (144 mm) diameter, 6 inches (152 mm) high with 100 cells per square inch (approx 15 per square centimetre). The wall thickness separating parallel rectangular channels running from end-face to end-face is around 17 thousandths of an inch (0.4 mm). The walls are porous, around 10 microns mean pore diameter. Alternate channels are blocked off at the ends so that the exhaust passes through the walls that trap particulates. As an example, such filters made of cordierite are sold under the name of Celcor by Corning Inc. Silicon carbide wallflow filters are-also known. Flow through cordierite honeycomb filters in which all channels are open are used for supporting 3-way catalysts in the treatment of exhaust gases from gasoline engines. These monolithic materials, wallflow and flowthrough filters are widely accepted by the automotive industry as they meet the stringent regulations on mechanical integrity when used on vehicles. Any material to be used in the treatment of exhaust gases from internal combustion engines must satisfy industry requirements on mechanical integrity. Ceramic foams are also of interest for the treatment of exhaust emissions particularly in the treatment of carbonaceous particulates as they also are mechanically strong during use.

There is a requirement for improved methods of trapping and removing particulates from exhaust gas streams. One of the main challenges with achieving highly efficient filtration of particulates from gas streams is minimising the associated pressure drop across the filter caused by the build up of particulates, by successfully regenerating the filter, before the filter clogs up. When a filter is incorporated into a non-thermal plasma reactor the latter can be powered continuously or intermittently when regeneration is required. A number of reactor devices have been proposed employing non-thermal plasmas by themselves or in combination with catalyst materials, the so-called plasma-catalyst approach, for treatment of diesel exhaust emissions. The combination of a plasma with a substrate (for example, a filter material) that acts as a particulate trap is known. Particulates trapped in this way can be oxidised by the plasma in the presence or absence of catalysts. Species implicated in the mechanism of oxidation are discussed in WO 01/30485 and the article by Thomas et al, ‘Non-thermal Plasma Aftertreatment of Particulates—Theoretical Limits and Impact on Reactor Design’, SAE 2000-01-1926 and include O, OH, O₃, NO₂, NOₓ and electronically excited species. The plasma catalyst approach can also be used for the removal of nitrogen oxides by selective catalytic reduction. Examples of the use of this plasma catalyst approach are described in WO 00/43102, WO 00/71866 and in the international patent application PCT/GB02/01229.

It has been demonstrated that non-thermal plasmas can be generated when the substrate material contained between electrodes is in the form, for example, of spheres, for example in a packed bed reactor such as a ferroelectric bed reactor or in a dielectric barrier reactor that contains for example spherical dielectric material such as alumina beads. Other forms of substrate material have been proposed such as a ceramic meshes, fragments, fibres or the like and these are described in WO 01/59270 and WO 00/51714. The existence of narrow gaps, which may be referred to as microgaps, between substrate components of dielectric material in spherical form facilitates plasma formation, the plasma being initiated in the microgaps and expanding to fill wider gaps nearby. A similar effect can occur where the bed comprises beads or pellets of shapes other than spherical. It has been suggested that such spheres, beads, or pellets, or the like could be replaced with monolithic foams, or honeycomb substrates. However, the absence of microgaps in such monolithic substrate configurations means that in practice it is very difficult to generate plasma in the open channels, which they contain.

We have found unexpectedly that it is possible by choice of reactor structural configuration and a specified relationship between electrode spacing and the peak applied voltage to cause plasma formation in such monolithic substrate configurations at reasonable applied excitation voltages and the invention is based upon this discovery.

According to the invention, in one of its aspects, there is provided a method of manufacturing a non-thermal plasma reactor for the treatment of a gaseous medium comprising a monolithic substrate of dielectric material having gas passages therethrough, means for constraining gaseous medium to flow through the passages of the substrate, at least one pair of electrodes spaced apart with said monolithic substrate between them, at least one of the electrodes having its entire surface which faces the other electrode in intimate contact with a layer of dielectric barrier material, wherein the parameters of the monolithic substrate and dielectric barrier are chosen in relation to the required minimum peak voltage Vi for producing a non-thermal plasma in gas within the said gas passages in accordance with the relationship given by Equation 1 herein.

In Equation 1 “Vi” is the said required minimum peak voltage needed to be applied across the electrodes in order to generate the required Vplasma, where Vplasma is the peak voltage required to initiate a plasma discharge within the open area of a single gas passage of the monolithic substrate and is determined by the electrical characteristics of the gas in the gas passage, and the said parameters are defined as follows:

N is the height of a section of the monolithic substrate in terms of the number of gas passages contained within that height.

Iss, which is given by Equation 2, is the ratio of current in an open gas passage area of monolithic substrate divided by the combined current in two vertical walls of the monolithic substrate material which define the sides of the gas passage. In order to limit power loss in these walls this ratio should be not less than 1.0. To maximise plasma power this ratio Iss should be as high as possible.

Pc is the transverse pitch of the gas passages, assumed to be square in cross section, and the pitch Pc is measured from the mid point of one side wall of a gas passage to the mid point of the opposite side wall.

Tw is the thickness of the side walls of the gas passages.

Ho is the width and height of the cross sectional dimensions of the open area (where plasma is formed) of a gas passage.

Lc is the length (at right angles to the width and height) of a gas passage.

ρc is the resistivity of the monolithic substrate material.

Csa is the capacitance per unit surface area of the dielectric barrier.

εo is the permittivity of vacuum.

εa is the relative permittivity of gas in the gas passage (eg exhaust gas).

εc0 is the relative permittivity of the monolithic substrate material.

Cc is the combined capacitance of the two side wall columns.

Cbc:=Csa Tw.Lc

Cs is the capacitance of each individual wall component forming the top and bottom of a gas passage.

CS:=εc₀.εo.Ho.Lc.

$$Cs := ϵ {c}_{0} \cdot ϵ o \cdot Ho \cdot Lc \cdot \frac{2}{Tw}$$

Co is the capacitance of the open area of a gas passage (in the absence of plasma).

Co:=εo.εa.Lc.

ω is the frequency of the applied alternating voltage in units of radians per second.

j is the imaginary operator.

Rc is the resistance of each individual side wall column.

$$Rc := \frac{2 ρ c . Ho}{Tw . Lc}$$

Ro is the resistance of the gas within the open area of a gas passage.

The “required minimum peak voltage Vi” is a design requirement for the reactor system which may be determined by the available power supply system or what is a practical power supply system. In general it will be desirable for this to be as low as possible whilst meeting the requirement to generate a non-thermal plasma. In accordance with the invention key parameters for the

$$\begin{matrix}\begin{matrix}Vi := Vplasma \cdot N \cdot \\ [ \begin{matrix}1 + [ \begin{matrix}\frac{1}{[ \begin{matrix}\frac{[ ω \cdot [ ϵ {c}_{0} \cdot ϵ o \cdot ( Pc - Tw ) \cdot Lc \cdot \frac{2}{Tw} ] \cdot 1 j ]}{2} + \\ \frac{1}{2 [ ρ c \cdot \frac{Tw}{2} \cdot \frac{1}{( Pc - Tw ) \cdot Lc} ]}\end{matrix} ]} + \\ \frac{1}{ω \cdot N \cdot [ Csa \cdot ( Pc - Tw ) \cdot Lc ] \cdot 1 j}\end{matrix} ] \cdot \\ ( ω \cdot Co \cdot 1 j + \frac{1}{Ro} )\end{matrix} ]\end{matrix} & EQUATION 1 \\ \begin{matrix}ISS = \frac{ω \cdot ( ϵ o \cdot ϵ a \cdot Ho \cdot Lc \cdot \frac{1}{Ho} ) \cdot 1 j + \frac{1}{Ro}}{\frac{1}{[ \frac{1}{( ω \cdot 2 \cdot Cc \cdot 1 j + \frac{2}{Rc} )} + \frac{1}{[ ω \cdot ( CsaTw \cdot Lc ) \cdot 1 j ]} ]}} \cdot \\ \frac{1}{1 + [ \begin{matrix}\frac{1}{[ \frac{1}{( ω \cdot 2 \cdot Cc \cdot 1 j + \frac{2}{Rc} )} + \frac{1}{[ ω \cdot ( CsaTw \cdot Lc ) \cdot 1 j ]} ]} \cdot \\ [ \begin{matrix}\frac{1}{[ \begin{matrix}\frac{[ ω \cdot [ ϵ {c}_{0} \cdot ϵ o \cdot ( Pc - Tw ) \cdot Lc \cdot \frac{2}{Tw} ] \cdot 1 j ]}{2} + \\ \frac{1}{2 [ ρ c \cdot \frac{Tw}{2} \cdot \frac{1}{( Pc - Tw ) \cdot Lc} ]}\end{matrix} ] +} \\ \frac{1}{ω \cdot [ Csa \cdot ( Pc - Tw ) \cdot Lc ] \cdot 1 j}\end{matrix} ]\end{matrix} ]}\end{matrix} & EQUATION 2\end{matrix}$$

specification of the elecctrode configuration associated with a monolithic substrate such as a wallflow fliter are determined for a chosen peak voltage.

According to the invention, in another of its aspects, there is provided a non-thermal plasma reactor for the treatment of a gaseous medium comprising a monolithic substrate of dielectric material having gas passages therethrough and comprising a ceramic wallflow filter comprising an array of parallel rectangular passages separated by porous gas permeable walls, half of the passages being closed at one end and the other half of the passages being closed at the other end such that adjacent passages are respectively closed at opposite ends, whereby gaseous medium entering the open passages at one end is forced to pass through the permeable walls to escape via passages which are open at the other end, means for constraining gaseous medium to flow through the passages of the substrate, at least one pair of electrodes spaced apart with said monolithic substrate between them, at least one of the electrodes having its entire surface which faces the other electrode in intimate contact with a layer of dielectric barrier material, wherein, to reduced the minimum peak voltage required for producing a plasma in gas within the said gas passages below 30 kilovolts, the thickness of monolithic substrate between the electrodes is not greater than 11 mm. In a preferred arrangement, in order to reduce the minimum peak voltage required for producing a plasma in gas within the said gas passages below 10 kilovolts, the thickness of monolithic substrate between the electrodes is not greater than 6 mm.

Preferably, the wallflow filter comprises cordierite.

Alternatively, the monolithic substrate may comprise a ceramic honeycomb that can be of the flowthrough type or open pore foam, which may also be of cordierite. However, the wallflow filter or honeycomb or open pore foam may alternatively be fabricated from silicon carbide. The foam may a reticulated one or made by a gel casting process. The monolithic substrate may be fabricated from other materials including ceramic materials such as alumina.

A plasma reactor as aforesaid has application also for the treatment of air to be re-circulated to the cabins in an aircraft. There is a requirement to remove organisms such as bacteria, viruses, spores as well as other particulate material that may be in the recirculated air supply within aircraft cabins. Particulate material, which may be antigenic, can include degradation products from aircraft furnishings, dust-mite faeces and degradation products of human tissue such as dandruff. There is also an appreciation that it is necessary to remove odours that can occur periodically in the cabin. Also non-odorous gases present in the cabin may require removal. Examples of these gases are refrigerants, hydrocarbons, carbon monoxide, carbon dioxide and ozone.

For this purpose the monolithic substrate, wallflow filter or honeycomb, preferably comprises or is coated with a molecular sieve or zeolite material which acts to adsorb odorous gases. Alternatively, or additionally, gas passages of the monolithic substrate are packed with porous adsorbent material. Separate gas passages may contain different adsorbents or a combination of different adsorbents may be packed together into one, some or all of the gas passages.

The material of the monolithic substrate and adsorbent packed into its gas passages will also serve to trap particulates and the efficiency of such trapping of particulates is enhanced by the presence of an electric field which promotes electrostatic trapping. Further enhancement of particulate trapping is provided by incorporating a fibrous material in the gas passages of the monolithic substrate, wallflow filter or honeycomb. For example, a fibre having a diameter of the order of 0.1 micron will electrostatically trap microorganisms 0.3 microns in diameter.

Specific constructions of reactor embodying the invention will now be described by way of example and with reference to the drawings filed herewith, in which:

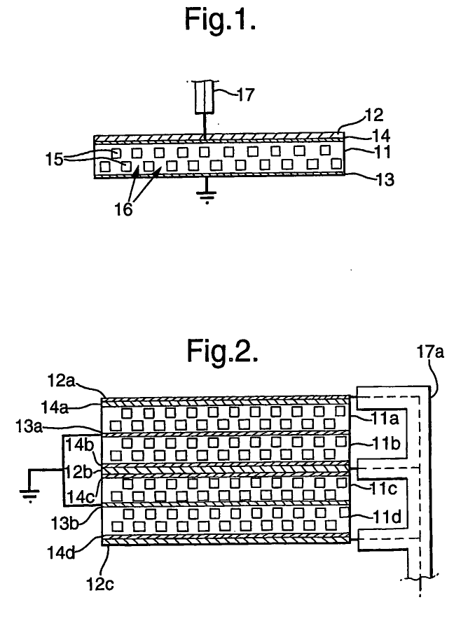

FIG. 1 is a diagrammatic part cross-sectional view of a first embodiment,

FIG. 2 is a diagrammatic part cross-sectional view of a second embodiment,

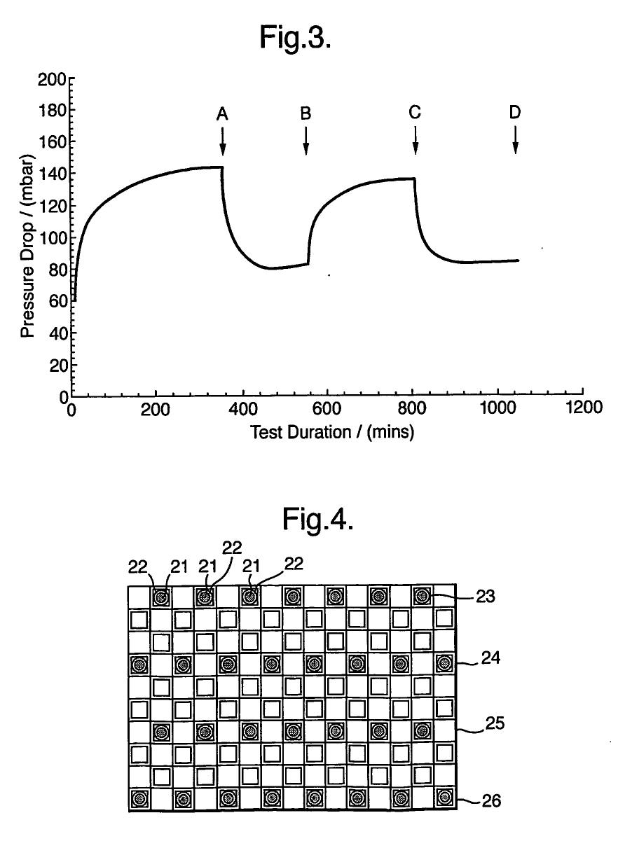

FIG. 3 is a graph showing experimental results using a reactor such as is shown in FIG. 1, and

FIG. 4 is a diagrammatic part cross-sectional view of a third embodiment.

Referring to FIG. 1, to facilitate the description there is shown in end view a rectangular slice 11 from a cordierite wallflow filter sandwiched between a pair of parallel plate electrodes 12, 13 shown in cross-section. The parallel plate electrodes 12, 13 have a rectangular surface area corresponding to the dimensions of the sides of the rectangular slice 11 of wallflow filter to which the electrodes are applied. In this example, a single layer of dielectric barrier material between the electrode plates 12, 13 is provided by a thin film layer 14 of alumina in contact with the high voltage electrode plate 12. The entire surface of electrode plate 12 facing earthed electrode 13 is covered by the dielectric barrier layer 14, which is also in intimate contact with the rectangular slice 11 of wallflow filter. A thin film layer thickness of 1 mm is a convenient thickness.

Open ends of gas passages in the wallflow filter can be seen at 15 in FIG. 1. Adjacent gas passages at 16 are closed at the end seen in FIG. 1, but open at the opposite end. A high voltage lead for applying potential to electrode plate 12 is illustrated at 17.

The thickness of the rectangular slice 11 corresponds to the thickness of two rows of gas passages in a wallflow filter of the type mentioned above, thus representing a separation between the electrode plates 12, 13 of slightly less than 6 mm. For such an embodiment, we have found plasma is generated in all of the gas passages when an alternating or pulsed voltage at a peak level of 9 kilovolts is applied. A cell density of 100 cells per square inch and wall thickness of around 0.4 mm are convenient parameters for the substrate material.

If the thickness of the rectangular slice 11 is increased, higher voltage is required and, above a certain thickness, it becomes effectively impossible to establish plasma in the gas passages or such high peak voltages are required that they are not of practical use. However, we have demonstrated plasma generation with the thickness of the rectangular slice 11 corresponding to 4 rows of gas passages, which represents a spacing between the electrode plates 12, 13 of slightly less than 11 mm. For this, a minimum peak voltage of an alternating or pulsed supply of 30 kilovolts was required.

FIG. 2 illustrates an arrangement for providing a reactor with an increased gas flow capacity. Components which correspond with those shown in FIG. 1 are referenced with the same reference numerals. The reactor of FIG. 2 effectively corresponds to a stacked array of reactors of the form shown in FIG. 1. In this example, four rectangular slices 11a, 11b, 11c, 11d are positioned between electrode plates 12a, 12b, 12c and 13a, 13b. The earthed electrode plates 13a, 13b are midway between the high voltage electrode plates 12a, 12b and 12b, 12c respectively. A high voltage lead for applying potential to the electrode plates 12a, 12b, 12c is illustrated at 17a. In this example, again only a single dielectric barrier layer is provided between the respective pairs of electrode plates. The respective dielectric barrier layers are shown at 14a, 14b, 14c, and 14d, the central high voltage electrode plate 12b having a dielectric barrier layer on both surfaces.

The reactors of these examples are particularly useful for the treatment of carbonaceous particulates including ultrafine material which is oxidised during its passage through the plasma and does not therefore have to be trapped in the walls of the wallflow filter, which would demand an impracticably small pore size. Larger particulates are trapped and thus held for a longer residence time for exposure to the plasma for complete oxidation.

The compact form of the reactors and low voltage operation are particularly suitable for use in vehicle applications for treatment of the exhaust gases from internal combustion engines.

This is illustrated in the results of an experiment shown FIG. 3. Exhaust from a diesel Genset was passed through a reactor similar to that shown in FIG. 1. The reactor comprised a cordierite wall flow filter with 100 cells per square inch, three rows high about 70 mm wide and 50 mm in length sandwiched between plate electrodes, only one of which was provided with a surface layer dielectric barrier.

Soot in the exhaust is trapped in the filter of the reactor which was operated for the first six hours without any applied voltage (no plasma). The graph of FIG. 3 shows pressure drop in millibars as ordinate against time as abscissa. The accumulation of soot on the filter causes the increase seen in pressure drop during the first six hours operation up to the point marked “A”. At this point “A” generation of non-thermal plasma in the reactor was initiated leading to a rapid fall in pressure drop consequent upon the oxidation of the soot by the non-thermal plasma. The plasma was switched off at point “B” and accumulation of soot leads again to rising pressure drop until point “C”, when the generation of non-thermal plasma was again initiated. The experiment finished at point “D”.

It may be required to have a plasma generated in the reactor continuously, in order, for example, to oxidise ultrafine particulates which, not being trapped by the filter, would otherwise escape from the reactor. However, where continuous generation of plasma is not required, intermittent operation such as demonstrated in FIG. 3 can be achieved automatically by use of a pressure drop sensor which switches on the plasma when the pressure drop reaches a preset level and then switches it off again when the pressure drop has fallen to a (lower) preset level.

Cordierite wallflow filters come in a range of cell geometries with defined cell pitch, (cells per square inch) and wall thickness. Examples of currently available wall flow filters are: 100 cpsi 0.43 mm wall thickness (as mentioned above), 200 cpsi 0.31 mm wall thickness and 300 cpsi 0.31 mm wall thickness.

Generation of non thermal plasma within the open area of cordierite monolithic wallflow filter is extremely difficult due to the physical construction of the monolith. Displacement currents flowing in the monolith structure as a result of applied high AC or pulsed voltages will flow through the open cell area and cordierite walls parallel to the direction of electric field. The displacement currents flowing in the cordierite walls do not contribute to plasma formation and hence reduce the overall plasma generation efficiency. It is therefore prudent to minimise wall currents in order to maximise current flow in the open cell area where plasma is generated, and thus improve the efficiency with which the applied electrical energy is transferred into the plasma.

Displacement currents are a function of the magnitude of the applied AC or pulsed voltage and the physical properties of the cordierite material, including its resistivity and dielectric constant. For given properties we have calculated the effect of wall thickness on wall currents and plasma currents.

The resistivity and relative dielectric constant of a 100 cpsi cordierite wall flow filter as measured is around 2.5×10⁹ ohm cm and 5.8 respectively.

In our calculation we have assumed dry clean cordierite for which the high resistivity does not significantly contribute to the current flowing in the walls. It should be noted, however, that high humidity and soot loading will greatly affect current flow and hence distribution of currents. This characteristic is difficult to quantify as it will vary with time and operating conditions.

Our calculations have shown, not unexpectedly, that the current in the air gap is maximum when the ratio of cordierite wall thickness to cell pitch is zero, i.e. infinitely thin wall, and is the ideal condition for plasma generation within the open cell area. More usefully, our calculation shows the way in which the current in the air gap decreases rapidly as the wall thickness increases.

Taking the upper acceptable limit of wall thickness as that which results in equal currents in the open area (ie through the plasma) and the wall, our calculation shows this occurs for a wall thickness to cell pitch ratio of approximately 0.17. For a 100 cpsi monolith cell pitch of 2.54 mm, this corresponds to a wall thickness of 0.43 mm; for a 200 cpsi monolith cell pitch of 1.8 mm, this corresponds to a wall thickness of 0.31 mm. These dimensions are equal to the wall thickness found in existing manufactured monoliths, which are thus just able to meet the minimum efficiency requirement implied by the limit we have set.

A preferred current distribution would be say 0.8 within the open cell area and 0.2 within the walls, however the very thin wall thickness required, (wall thickness to cell pitch ratio of approximately 0.05), would be extremely difficult to manufacture.

A solution to the problem of achieving this required ratio would be to maintain the present wall thickness and cell height dimensions and to increase the width of the cell pitch so as to form rectangular shaped cells rather than the present square shaped cells.

Alternatively improved current distribution can be achieved if the dielectric constant of the material from which the wallflow filter is constructed can be reduced. Or, desirably, both the cell width could be increased and the dielectric constant reduced.

Monolithic wallflow filters made from silicon carbide are produced by Ibiden Europa. Such filters are described in an article by K.Ohno et al “Characterisation of SiC-DPF for passenger car” (SAE 2000-01-0185). The filter configuration is similar to that described above for cordierite and such silicon carbide filters provide an alternative to cordierite for use in accordance with the present invention. The silicon carbide filters as manufactured are formed with a silicon carbide ceramic sealing skin around the sides of the filter. By modifying the manufacturing process so that this sealing skin (which has a high electrical resistivity), whilst remaining non-porous, has a thickness of the order of 1 mm, the resultant sealing skin could serve as a dielectric barrier for an electrode plate secured thereon. A pair of opposed electrodes positioned on the sealing skin on opposite sides of the filter may be provided by screen printing. In this way a compact non-thermal plasma reactor is produced with relatively few components and uniform thermal expansion characteristics.

It will be appreciated that electrodes for the reactor may be provided in a variety of different ways. Rather than providing continuous plate electrodes extending along the full length of the sides of the reactor, the plates may be broken up into two or more separated electrode plates. Electrical power need not necessarily be supplied to all such separated electrode plates simultaneously, and but it may be applied sequentially in response to detection of preset levels of pressure drop. In this way, the electrical power supplied can be matched to the need for soot removal to regenerate the filter.

FIG. 4 illustrates a reactor similar to that shown in FIG. 2, but with electrodes provided by rods 21 each of which is encased, for example by plasma spraying, with a dielectric coating 22. The rods are received within alternate channels in rows referenced 23, 24, 25, 26 of the wallflow filter monolith. This provides a variety of options for applying alternating or pulsed voltage potentials across the intervening body of the filter. For example, the rods in rows 24, 26 may be held at earth potential and the alternating or pulsed high-voltage potential applied to the rods in rows 23, 26. Alternatively, a phased alternating supply may be connected with the 0° phase on row 23, the 120° phase on row 24 and the 240° phase on row 25.

The wallflow filter material can conveniently contain catalyst material for assisting in the removal of carbonaceous material or for treatment of nitrogen oxides or for treatment of both. The plasma can be used solely for treatment of carbonaceous material. It can also be used for the combined treatment of particulate material and nitrogen oxides through initial conversion of nitric oxide to nitrogen dioxide and the selective catalytic reduction of nitrogen dioxide. With an appropriate catalyst, specifically a silver doped activated alumina, the reactor can also be used for selective catalytic reduction of nitric oxide in exhaust gases without prior conversion of this oxide to nitrogen dioxide. The ability to contain catalyst material in the filter material makes for a compact design for treatment of exhaust gases and is, in this respect at least, an advantage over the use of a separate compartment of catalytic material outside the plasma region of the reactor. The plasma can also be used for the simultaneous treatment of carbonaceous material and nitrogen oxides through reaction of nitrogen oxides and the carbonaceous material.

Treatment to remove nitrogen oxides may be provided by a separate dedicated reactor downstream of the reactor for filtration and removal of carbonaceous particulates. This downstream reactor may either provide the entire facility for nitrogen oxide removal or be simply to mop up any nitrogen oxides not removed by selective catalytic reduction carried out in the wallflow filter plasma reactor. Residual nitrogen oxides to be mopped up can be nitric oxide produced from the reaction of nitrogen dioxide with carbonaceous material.

The downstream reactor may incorporate an adsorber catalyst for removal of nitrogen oxides. An adsorber catalyst is a compound that adsorbs nitrogen oxides in particular nitric oxide to form a solid metal nitrate salt under lean operating conditions. Barium-containing compounds and other alkaline earth compounds act as adsorber catalysts. Examples of such catalysts are barium-zeolites, barium-aluminas, barium-silica-aluminas and barium-containing inorganic phosphates. Barium nitrate is an example of a solid metal nitrate formed under lean operating conditions. A rich pulse in the exhaust gases causes hydrocarbon to reduce the adsorbed nitrate species to nitrogen. The rich pulse of hydrocarbon may be activated in a non-thermal plasma before contact with the adsorber catalyst material although unactivated hydrocarbon that has not passed through a plasma region can be used for contacting the catalyst. The downstream reactor may also contain a catalyst for the selective catalytic reduction (SCR) of nitrogen oxides or combination of adsorber material and SCR material. These catalytic materials either alone or in combination can be used inside or outside of a plasma region, may be mixed together for example as a mixed coating on a honeycomb filter or may be used in separate compartments in the downstream reactor.

The wallflow filter reactors of the foregoing examples may be adapted for use as a filter for recirculated aircraft cabin air. For this the wallflow filter is either fabricated from or coated with a molecular sieve or zeolite material for adsorbing odorous gases and, in addition, the gas passages may be packed with porous adsorbents. (Note that materials for adsorbing odorous gases in recirculated aircraft cabin air are distinct from adsorber catalysts). The adsorbent materials are selected according to the gaseous species required to be adsorbed. As molecular sieves or adsorbents such as activated carbon may be selective to particular gaseous species, a combination of adsorbents may be required. These may be combined together in one, some, or all of the gas passages of the wallflow filter, or different adsorbents may be accommodated in separate gas passages.

Further, for improving the trapping efficiency of particulates, and particularly microorganisms, the gas passages include a packing of fibres. Fibre of diameter of the order of 0.1 micron is capable of electro-statically trapping microorganisms of the order of 0.3 micron diameter. Examples of fibres that can be used in the gas passages are Saffil alumina, Nextel fibre produced by 3M, silicon carbide for example Nicalon and Tyranno as produced by Nippon Carbon and Ube Chemicals. Saffil is a porous ceramic fibre. Non-porous fibres such as glass fibres can also be used as can melt-blown aluminosilicate fibres such as Kaowool. Other fibres can be used providing they are thermally stable at the operating temperature of the plasma, typically 200° C. Fibres can consist of a number of smaller diameter fibres wound together at the manufacturing stage to form a thread, or woven into mats or meshes.

Gas passages in the wallflow filter can also be packed with fine fibre stainless steel filter material or non-metallic thread or a combination of one or more of these materials with one or more adsorbent materials.

A filter containing adsorbent material and/or fibrous material as described above is capable of trapping organisms, particulate matter and adsorbing gases. It is thus has usefulness for both the automotive and aircraft air treatment applications. The plasma destroys the organisms and particulate matter but may not destroy the adsorbed gases. The filter can be treated at an aircraft destination to remove the adsorbed gases either in situ or after removal from the aircraft if the plasma has not destroyed adsorbed species on the adsorbent. However, it is noted that the physical state of an adsorbed species is similar to a condensed liquid which may therefore be expected to aid destruction of adsorbate by the plasma.

The established structural integrity of wallflow filters is an advantageous feature of the reactors of the foregoing examples for both automotive and aircraft applications.

The invention is not restricted to the details of the foregoing examples. For instance, dielectric barrier layers 14, 14a, 14b, 14c, 14d can be provided on all facing electrode surfaces, that is on the upper surface of electrode plate 13 of the embodiment shown in FIG. 1 and both surfaces of the electrode plates 13a, 13b of the embodiment shown in FIG. 2. The dielectric barrier layers need not necessarily be of alumina but may be of any suitable dielectric material.

The striking potential of the plasma can be reduced by forming metal contacts in at least one gas passage of the monolith, that is by forming a triple junction, for example by placing a metallic rod in a gas passage in contact with the dielectric material of a wall of the gas passage.

For some applications it may be possible to fabricate the wallflow filter or other monolithic substrate from catalytic material, rather than incorporating catalytic material as an impregnation or coating. In addition, the non-thermal plasma reactor described herein in which a filter material such as a wallflow monolith is contained within the plasma region may be combined with a high efficiency particulate air (HEPA) filter. In this combination the filter is placed downstream of the reactor and is particularly useful when the reactor is used to kill microorganisms so that debris contained in the exhaust gases from the reactor is collected in the HEPA filter.

Application has been described for treatment of air recirculated to an aircraft cabin. It will be appreciated that the wallflow filter reactor of the examples may equally well be used for treatment of air provided by any air circulation system, such as for a room or building, for example.

1. A non-thermal plasma reactor for the treatment of a gaseous medium comprising a monolithic substrate of dielectric material having gas passages (15, 16) therethrough and comprising a ceramic wallflow filter comprising an array of parallel rectangular passages separated by porous gas permeable walls, half of the passages being closed at one end and the other half of the passages being closed at the other end such that adjacent passages are respectively closed at opposite ends, whereby gaseous medium entering the open passages at one end is forced to pass through the permeable walls to escape via passages which are open at the other end,
means for constraining gaseous medium to flow through the gas passages of the substrate, at least one pair of electrodes spaced apart with said monolithic substrate between them, at least one of the electrodes having its entire surface which faces the other electrode in intimate contact with a layer of dielectric barrier material, characterized in that, to reduce the minimum peak voltage required for producing a plasma in gas within the said gas passages below 30 kilovolts, the thickness of monolithic substrate between the electrodes is not greater than 11 mm.

2. A non-thermal plasma reactor as claimed in claim 1, further characterised in that, in order to reduce the minimum peak voltage required for producing a plasma in gas within the said gas passages below 10 kilovolts, the thickness of monolithic substrate between the electrodes is not greater than 6 mm.

3. A non-thermal plasma reactor as claimed in claim 1, further characterised in that the ceramic wallflow filter is fabricated from cordierite.

4. A non-thermal plasma reactor as claimed in claim 1, further characterised in that the monolithic substrate comprises or contains catalytic material for promoting reactions for removing unwanted constituents of a gaseous medium passed through the reactor.

5. A non-thermal plasma reactor as claimed in claim 1 for the treatment of air to be re-circulated to the cabins in an aircraft, further characterised in that the monolithic substrate comprises or is coated with a molecular sieve or zeolite material which acts to adsorb odorous gases.

6. A non-thermal plasma reactor as claimed in claim 1 for the treatment of air to be re-circulated to the cabins in an aircraft, further characterised in that gas passages of the monolithic substrate are packed with porous adsorbent material.

7. A non-thermal plasma reactor as claimed in claim 6, further characterised in that separate gas passages contain different adsorbents.

8. A non-thermal plasma reactor as claimed in claim 6, further characterised in that a combination of different adsorbents are packed together into one, some or all of the gas passages.
